(19) United States
(12) Patent Application Publication
(10) Pub. No.: US 2023/0339379 A1
(43) Pub. Date: Oct. 26, 2023

(54) PNEUMATIC SEAT CONTROL SYSTEM AND CONTROL METHOD OF VEHICLE, AND COMPUTER READABLE MEDIUM

(71) Applicant: ZF Automotive Technologies (Shanghai) Co., Ltd, Shanghai (CN)

(72) Inventors: Zhiwei HUANG, Shanghai (CN); Hai WANG, Shanghai (CN); Yuanyi CHENG, Shanghai (CN)

(21) Appl. No.: 18/015,778

(22) PCT Filed: Jul. 13, 2021
(86) PCT No.: PCT/CN2021/105905

§ 371 Date: Jan. 12, 2023

(30) Foreign Application Priority Data
Jul. 15, 2020 (CN) 202010680182.7

(51) Int. Cl. B60N 2/90; B60N 2/00

(52) U.S. Cl. CPC B60N 2/914; B60N 2/976; B60N 2/002

(57) ABSTRACT

A control system and method for a pneumatic seat of a vehicle and a computer-readable medium, the pneumatic seat including a plurality of airbags (11, 12, 13, 14, 15, and 16) corresponding to different parts of the body of an occupant, where the control system further includes an information collection module (3), a determining module (4), and a control module (2), and the information collection module (3) is configured to collect motion information of the vehicle and/or external road information; the determining module (4) is configured to determine, based on the motion information and/or the road information, whether the vehicle satisfies either of a first condition and a second condition, where the first condition is whether continuous changes have occurred or are about to occur on a motion status of the vehicle in a first time period, and the second condition is whether a change range of the motion status of the vehicle in a second time period is or is about to be greater than a set threshold; and the control module (2) is configured to: when either of the first condition and the second condition is satisfied, control inflation and deflation of at least one of the airbags (11, 12, 13, 14, 15, and 16), to move the body of the occupant to be adapted to the motion status of the vehicle and/or a change of the motion status of the vehicle, to reduce discomfort caused by carsickness.

### TECHNICAL FIELD

The invention relates to a safety system, a control method, and a medium, and in particular, to a control system and method for a pneumatic seat with a plurality of airbags provided at different positions, and a computer-readable medium.

### BACKGROUND ART

With the development of the automobile industry, in addition to people's requirements for safety, the requirements for vehicle comfort are also increasing. People are not only satisfied with position adjustment of vehicle seats, but expect the vehicle seats to provide an occupant with more comfortable ride experience. There are already some pneumatic seats installed with airbags or air pockets on the market, that is, airbags or air pockets are disposed at positions corresponding to the head, the shoulders, the waist and back of an occupant and the seat cushion in a vehicle seat, but the existing pneumatic seats basically rely on the active adjustment by the occupant to inflate and deflate the airbags or air pockets to achieve the most comfortable riding mode. In addition, the existing pneumatic seat adjustment system focuses on the adjustment of the sitting posture or the sitting comfort, and when the vehicle is in intense driving or bumping conditions, it is inevitable that the occupant suffers from carsickness, and it is difficult to reduce discomfort of the occupant due to carsickness even if the occupant sits in a comfortable seat.

### SUMMARY OF THE INVENTION

To resolve the defects in the prior art that the adjustment of airbags in a pneumatic seat depends on an active operation by an occupant, and that the discomfort of the occupant due to carsickness under conditions of vehicle bumping and the like is difficult to alleviate, the invention provides a control system and method for a pneumatic seat of a vehicle and a computer-readable medium that alleviate carsickness by utilizing the airbags in the pneumatic seat, and can automatically adjust a posture of the occupant especially during intense driving or when it is predicted that the occupant may have carsickness.

The object of the invention is realized by the following technical solutions:
A control system for a pneumatic seat of a vehicle, the pneumatic seat including at least one headrest airbag, a shoulder support airbag, at least one side airbag, at least one lumbar support airbag, at least one leg support airbag, and at least one seat cushion airbag, where the control system for a pneumatic seat further includes an information collection module, a determining module, and a control module, where
the information collection module is configured to collect motion information of the vehicle and/or external road information;
the determining module is configured to determine, based on the motion information and/or the road information, whether the vehicle satisfies either of a first condition and a second condition, where the first condition is whether continuous changes have occurred or are about to occur on a motion status of the vehicle in a first time period, and the second condition is whether a change range of the motion status of the vehicle in a second time period is or is about to be greater than a set threshold; and
the control module is configured to: when either of the first condition and the second condition is satisfied, control inflation and deflation of one or more of the headrest airbag, the shoulder support airbag, the side airbag, the lumbar support airbag, the leg support airbag, and the seat cushion airbag, to move the body of an occupant to be adapted to the motion status of the vehicle and/or a change of the motion status of the vehicle.

In the control system, the information collection module collects the motion information and/or the road information, and the determining module determines the conditions of the vehicle and a road, to learn of whether being prone to carsickness is occurring, and therefore corresponding airbags in the pneumatic seat are controlled to enable the occupant to be adapted to the motion of the vehicle, thereby reducing possible discomfort caused by carsickness.

Preferably, the control system for a pneumatic seat further includes an occupant observation module configured to observe a physiological status of the occupant in the vehicle; and
the determining module is further configured to: determine whether the physiological status of the occupant is a state of being prone to carsickness or a state of being not prone to carsickness, and enable the determining of the first condition and the second condition only when the occupant is in the state of being prone to carsickness. The state of being prone to carsickness is generally a state in which the occupant is awake, for example, the occupant is not asleep, but is reading or chatting; while the state of being not prone to carsickness is, for example, a state in which the occupant is having a rest.

Preferably, the physiological status includes facial information and sitting posture information. For example, the physiological status of the occupant is observed through a facial expression, the vision, and a sitting posture, so as to determine whether the occupant is in the state of being prone to carsickness or in the state of being not prone to carsickness.

Preferably, the motion information includes: a velocity, an acceleration, an acceleration change amount, an angular velocity, and an angular acceleration change amount that are in a traveling direction of the vehicle; and a velocity in a direction perpendicular to the ground, and a force and a force change received in the direction perpendicular to the ground. The angular velocity is, for example, an angular yaw velocity, a pitch angular velocity, or the like.

Preferably, the road information includes a length, a width, a direction that are of a road, and an included angle between the road and the ground.

Preferably, the control module is further configured to control the inflation and deflation of one or more of the headrest airbag, the shoulder support airbag, the side airbag, the lumbar support airbag, the leg support airbag, and the seat cushion airbag, to push the occupant in a direction the same as a motion direction of the vehicle.

Preferably, the control module is further configured to control the inflation and deflation of one or more of the headrest airbag, the shoulder support airbag, the side airbag, the lumbar support airbag, the leg support airbag, and the seat cushion airbag, to push the occupant at a velocity the same as a velocity of the vehicle.

Preferably, when the determining module determines that continuous changes occur in the velocity and/or the acceleration in the traveling direction of the vehicle, the control module is configured to control inflation of the seat cushion airbag and/or the leg support airbag, to prevent a displacement of the occupant in the traveling direction of the vehicle, and/or the control module is configured to control inflation and deflation of the seat cushion airbag to generate vibration.

When the determining module determines that continuous changes occur in the angular velocity and/or the angular acceleration of the vehicle, the control module is configured to control inflation of the side airbag.

Preferably, when the determining module determines that a change occurs or continuous changes occur in the velocity of the vehicle in the direction perpendicular to the ground and/or a change occurs or continuous changes occur in the force received by the vehicle in the direction perpendicular to the ground, for example, when the road is bumpy, the control module is configured to control the inflation and deflation of one or more of the headrest airbag, the shoulder support airbag, the side airbag, the lumbar support airbag, the leg support airbag, and the seat cushion airbag, to reduce a displacement of the occupant in the direction perpendicular to the ground, to alleviate the discomfort caused by bumps on the road.

Preferably, when the determining module determines that continuous changes are about to occur on the motion status of the vehicle in the first time period, and/or determines that the change range of the motion status of the vehicle in the second time period is about to be greater than the set threshold, the determining module is further configured to determine a motion tendency of the vehicle based on the motion information of the vehicle and/or the external road information that are collected in real time by the information collection module; and
the control module is configured to: when the motion tendency satisfies either of the first condition and the second condition, control the inflation and deflation of one or more of the headrest airbag, the shoulder support airbag, the side airbag, the lumbar support airbag, the leg support airbag, and the seat cushion airbag, to move the body of the occupant to be adapted to the motion status of the vehicle and/or a change of the motion status of the vehicle.

Preferably, the control module includes a detection unit, a calculation unit, and an execution unit, where
the detection unit is configured to obtain current air pressures in the airbags of the pneumatic seat;
the calculation unit is configured to determine inflation parameters and deflation parameters of the airbags based on the motion information and the current air pressures; and
the execution unit is configured to execute the inflation and deflation of the airbags based on the inflation parameters and the deflation parameters of the airbags.

Preferably, the execution unit is configured to: before, when, or after at least some of the airbags of the pneumatic seat are inflated at a first inflation speed, deflate at least some other airbags of the pneumatic seat at a second deflation speed. The first inflation speed may be the same as or different from the second deflation speed.

Preferably, the execution unit is configured to: after at least one airbag of the pneumatic seat is inflated at a third inflation speed to a first pressure, inflate the airbag at a fourth inflation speed to a second pressure. For example, the third inflation speed is greater than the fourth inflation speed, that is, quick inflation is performed first and then slow inflation is performed. In another preferred solution, it is also feasible that the third inflation speed is less than or equal to the fourth inflation speed.

The invention further provides a control method for a pneumatic seat of a vehicle, the pneumatic seat including at least one headrest airbag, a shoulder support airbag, at least one side airbag, at least one lumbar support airbag, at least one leg support airbag, and at least one seat cushion airbag, where the control method for a pneumatic seat includes:
S1: collecting motion information of the vehicle and/or external road information;
S2: determining, based on the motion information and/or the road information, whether the vehicle satisfies either of a first condition and a second condition, and if either of the first condition and the second condition is satisfied, proceeding to step S3; or if neither the first condition nor the second condition is satisfied, returning to step S1, where the first condition is whether continuous changes have occurred or are about to occur on a motion status of the vehicle in a first time period, and the second condition is whether a change range of the motion status of the vehicle in a second time period is or is about to be greater than a set threshold; and
S3: controlling inflation and deflation of one or more of the headrest airbag, the shoulder support airbag, the side airbag, the lumbar support airbag, the leg support airbag, and the seat cushion airbag, to move the body of an occupant to be adapted to the motion status of the vehicle and/or a change of the motion status of the vehicle.

In the control method, through the collection of and determination based on the motion information and/or the road information, whether being prone to carsickness is occurring is learned of, and corresponding airbags in the pneumatic seat are controlled to enable the occupant to be adapted to the motion of the vehicle, thereby reducing possible discomfort caused by carsickness.

Preferably, before step S2, the method further includes:
ST1: observing a physiological status of the occupant in the vehicle; and
ST2: determining whether the physiological status of the occupant is a state of being prone to carsickness or a state of being not prone to carsickness, and if the occupant is in the state of being prone to carsickness, proceeding to step S2; or if the occupant is in the state of being not prone to carsickness, returning to step ST1. The state of being prone to carsickness is generally a state in which the occupant is awake, for example, the occupant is not asleep, but is reading or chatting; while the state of being not prone to carsickness is, for example, a state in which the occupant is having a rest.

Preferably, the physiological status includes facial information and sitting posture information, for example, the physiological status of the occupant is observed through a facial expression, the vision, and a sitting posture, so as to determine whether the occupant is in the state of being prone to carsickness or in the state of being not prone to carsickness; and/or
steps ST1 and ST2 are performed before step S1 or performed simultaneously with step S1.

Preferably, the motion information includes: a velocity, an acceleration, an acceleration change amount, an angular velocity, and an angular acceleration change amount that are in a traveling direction of the vehicle; and a velocity in a direction perpendicular to the ground, and a force and a force change received in the direction perpendicular to the ground; and/or
the road information includes a length, a width, a direction that are of a road, and an included angle between the road and the ground.

Preferably, the inflation and deflation of one or more of the headrest airbag, the shoulder support airbag, the side airbag, the lumbar support airbag, the leg support airbag, and the seat cushion airbag are controlled in step S3, to push the occupant in a direction the same as a motion direction of the vehicle.

Preferably, the inflation and deflation of one or more of the headrest airbag, the shoulder support airbag, the side airbag, the lumbar support airbag, the leg support airbag, and the seat cushion airbag are controlled in step S3, to push the occupant at a velocity the same as a velocity of the vehicle.

Preferably, when it is determined, in step S2, that continuous changes occur in the velocity and/or the acceleration in the traveling direction of the vehicle,
step S3 includes: controlling inflation of the seat cushion airbag and/or the leg support airbag, to prevent a displacement of the occupant in the traveling direction of the vehicle, and/or controlling inflation and deflation of the seat cushion airbag to generate vibration.

Preferably, when it is determined, in step S2, that continuous changes occur in the angular velocity and/or the angular acceleration of the vehicle,
step S3 includes: controlling inflation of the side airbag.

Preferably, when it is determined, in step S2, that a change occurs in the velocity of the vehicle in the direction perpendicular to the ground and/or a change occurs in the force received by the vehicle in the direction perpendicular to the ground, for example, when the road is bumpy,
step S3 includes: controlling the inflation and deflation of one or more of the headrest airbag, the shoulder support airbag, the side airbag, the lumbar support airbag, the leg support airbag, and the seat cushion airbag, to reduce a displacement of the occupant in the direction perpendicular to the ground, to alleviate the discomfort caused by bumps on the road.

Preferably, step S2 includes:
S21: determining whether continuous changes are about to occur on the motion status of the vehicle in the first time period, or whether the change range of the motion status of the vehicle in the second time period is about to be greater than the set threshold, and if either the first condition or the second condition is satisfied, proceeding to step S22; or if neither the first condition nor the second condition is satisfied, returning to step S1; and
S22: determining a motion tendency of the vehicle based on the motion information of the vehicle and/or the external road information that are collected in real time, and if the motion tendency satisfies either of the first condition and the second condition, proceeding to step S3; or if neither the first condition nor the second condition is satisfied, returning to step S1.

Preferably, step S3 includes:
S31: obtaining current air pressures in the airbags of the pneumatic seat;
S32: determining inflation parameters and deflation parameters of the airbags based on the motion information and the current air pressures; and
S33: executing the inflation and deflation of the airbags based on the inflation parameters and the deflation parameters of the airbags.

Preferably, step S33 includes: before, when, or after at least some of the airbags of the pneumatic seat are inflated at a first inflation speed, deflating at least some other airbags of the pneumatic seat at a second deflation speed. The first inflation speed may be the same as or different from the second deflation speed.

Preferably, step S33 includes: after at least one airbag of the pneumatic seat is inflated at a third inflation speed to a first pressure, inflating the airbag at a fourth inflation speed to a second pressure. For example, the third inflation speed is greater than the fourth inflation speed, that is, quick inflation is performed first and then slow inflation is performed. In another preferred solution, it is also feasible that the third inflation speed is less than or equal to the fourth inflation speed.

The invention further provides a computer-readable medium, where the computer-readable medium stores computer instructions that, when executed by a processor, implement the steps of the control method for a pneumatic seat of any one of the above.

The technical effects obtained by the invention are as follows:
1. In the case of being prone to carsickness, for example, in the case of an intense driving environment and where it is predicted that being prone to carsickness is about to occur (rapid acceleration and deceleration, sharp turns, and bumpy road), the corresponding airbags can be inflated in time, such that the occupant is adapted to the motion status of the vehicle or a change of the motion status, to alleviate the discomfort caused by carsickness.
2. Before the function of alleviating carsickness is enabled, the occupant observation module in the vehicle is used to observe the physiological status (for example, a facial expression, the vision, a sitting posture, etc.) of the occupant to learn of whether the occupant is in the state of being prone to carsickness, and only when the occupant is in the state of being prone to carsickness, the airbags starts to be used to adjust the body of the occupant to reduce carsickness.
3. The inflation and deflation parameters of each airbag are set for the motion status of the vehicle, and the airbags are controlled in a targeted manner to alleviate the discomfort caused by carsickness.

### BRIEF DESCRIPTION OF THE DRAWINGS

FIG. 1 is a structural block diagram of a control system for a pneumatic seat according to an embodiment of the invention;

FIG. 2 is a flowchart of a control method for a pneumatic seat according to an embodiment of the invention;

FIG. 3 is a flowchart of a control method for a pneumatic seat according to another embodiment of the invention;

FIG. 4 is a structural block diagram of a control system for a pneumatic seat according to another embodiment of the invention;

FIG. 5 is a flowchart of a control method for a pneumatic seat according to still another embodiment of the invention;

FIG. 6 is a structural block diagram of a control system for a pneumatic seat according to still another embodiment of the invention;

FIG. 7 is a flowchart of specific inflation and deflation steps of a control method for a pneumatic seat according to yet another embodiment of the invention; and

FIG. 8 is a flowchart of a control method for a pneumatic seat according to another preferred embodiment of the invention.

### DETAILED DESCRIPTION OF EMBODIMENTS

The specific implementations of the invention will be further described below with reference to the accompanying drawings.

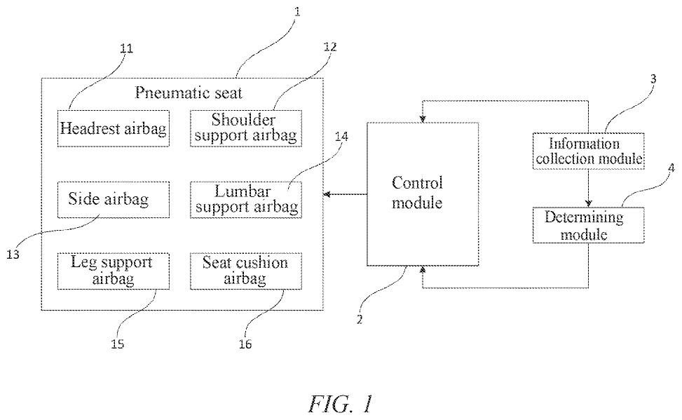

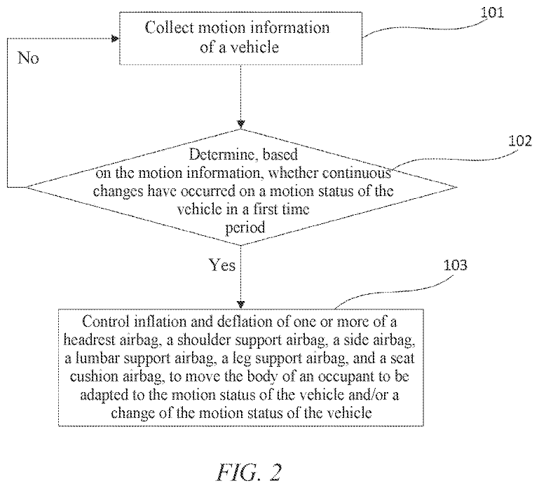

A control system and method for a pneumatic seat of a vehicle according to an embodiment are described with reference to FIG. 1 and FIG. 2, respectively. Specifically, referring to FIG. 1 first, the control system for a pneumatic seat of a vehicle of the embodiment is introduced. The control system for a pneumatic seat includes a pneumatic seat, the pneumatic seat including at least one headrest airbag 11, a shoulder support airbag 12, at least one side airbag 13, at least one lumbar support airbag 14, at least one leg support airbag 15, and at least one seat cushion airbag 16. The control system for a pneumatic seat further includes a control module 2, an information collection module 3, and a determining module 4, where the information collection module 3 is configured to collect motion information of the vehicle. The determining module 4 is configured to determine, based on the motion information, whether the vehicle satisfies a first condition, where the first condition is whether continuous changes have occurred on a motion status of the vehicle in a first time period. The control module 2 is configured to: when the first condition is satisfied, control inflation and deflation of one or more of the headrest airbag 11, the shoulder support airbag 12, the side airbag 13, the lumbar support airbag 14, the leg support airbag 15, and the seat cushion airbag 16, to move the body of an occupant to be adapted to the motion status of the vehicle and/or a change of the motion status of the vehicle.

The motion information includes: a velocity, an acceleration, an acceleration change amount, an angular velocity, and an angular acceleration change amount that are in a traveling direction of the vehicle; and a velocity in a direction perpendicular to the ground, and a force and a force change received in the direction perpendicular to the ground. Through these motion information, whether the vehicle is in a state of being likely to cause the occupant to feel carsickness, for example, whether continuous changes occur in the velocity of the vehicle, continuous steering occurs, or the vehicle shakes in the direction perpendicular to the ground due to bumps on the road, may be determined. When the determining module determines, based on the above information, that the vehicle is in the state of being likely to cause the occupant to feel carsickness, the control module adjusts the body of the occupant by inflating and deflating the airbags in the pneumatic seat, such that the occupant is adapted to the motion of the vehicle, thereby reducing the discomfort caused by carsickness.

Specifically, in one case, the control module is configured to control the inflation and deflation of one or more of the headrest airbag, the shoulder support airbag, the side airbag, the lumbar support airbag, the leg support airbag, and the seat cushion airbag, to push the occupant in a direction the same as a motion direction of the vehicle. For example, during continuous steering, the occupant is pushed, by controlling the inflation of some of the airbags and the deflation of some other airbags, to move the body of the occupant toward the direction the same as the motion direction of the vehicle, such that the occupant moves with the vehicle, to alleviate the discomfort caused during the continuous steering.

More specifically, the determining module 4 is configured to: when it is determined that continuous changes occur in the angular velocity and/or the angular acceleration of the vehicle (for example, the continuous steering occurs), the control module 2 is configured to control the inflation of the side airbag 13. The side airbag 13 is disposed on each of both sides of the pneumatic seat, and the inflation of the side airbag enables the occupant to be supported on both sides by the side airbags, such that a displacement of the occupant toward the side part is limited to a certain extent during steering, thereby reducing the discomfort caused by the continuous steering.

In another case, for example, when there are continuous bumps on the road, the determining module 4 is configured to determine that continuous changes occur in the velocity of the vehicle in the direction perpendicular to the ground and/or continuous changes occur in the force received by the vehicle in the direction perpendicular to the ground, and the control module 2 is configured to control the inflation and deflation of one or more of the headrest airbag, the shoulder support airbag, the side airbag, the lumbar support airbag, the leg support airbag, and the seat cushion airbag, to reduce a displacement of the occupant in the direction perpendicular to the ground. For example, the headrest airbag 111, the lumbar support airbag 14, the leg support airbag 15, and the seat cushion airbag 16 are inflated to strengthen the support for the occupant, such that when the road is bumpy, an impact of the motion of the vehicle in the direction perpendicular to the ground on the occupant is weakened.

Referring to FIG. 2, the control method for a pneumatic seat in the embodiment is described, where the method includes the following steps:
step 101: collecting motion information of the vehicle;
step 102: determining, based on the motion information, whether continuous changes have occurred on a motion status of the vehicle in a first time period, and if yes, proceeding to
step 103; or if no, returning to step 101, where continuous changes occurring on the motion status is, for example, continuous changes occurring in the velocity of the vehicle, continuous steering occurring, or the vehicle shaking in the direction perpendicular to the ground due to bumps on the road; and
step 103: controlling inflation and deflation of one or more of the headrest airbag, the shoulder support airbag, the side airbag, the lumbar support airbag, the leg support airbag, and the seat cushion airbag, to move the body of an occupant to be adapted to the motion status of the vehicle and/or a change of the motion status of the vehicle.

Specifically, for example, when continuous changes occur in the angular velocity and/or the angular acceleration of the vehicle (for example, the continuous steering occurs), the inflation of the side airbag is controlled to provide support for the occupant on both sides. For another example, when there are continuous bumps on the road, that is, it is determined in step 102 that continuous changes occur in the velocity of the vehicle in the direction perpendicular to the ground and/or continuous changes occur in the force received by the vehicle in the direction perpendicular to the ground, the headrest airbag, the lumbar support airbag, the leg support airbag, and the seat cushion airbag are inflated in step 103, to strengthen the support for the occupant, such that when the road is bumpy, an impact of the motion of the vehicle in the direction perpendicular to the ground on the occupant is weakened.

In another preferred embodiment, the determining module 2 in the control system (referring to FIG. 1) for a pneumatic seat of a vehicle is configured to determine whether the second condition is satisfied, where the second condition is determining, based on the motion information, whether a change range of the motion status of the vehicle in a second time period is greater than a set threshold, that is, the determining module is configured to determine whether the motion status of the vehicle reaches a specific change range, and if yes, the control module is configured to control the inflation and deflation of one or more of the headrest airbag, the shoulder support airbag, the side airbag, the lumbar support airbag, the leg support airbag, and the seat cushion airbag, to move the body of the occupant to be adapted to the motion status of the vehicle and/or a change of the motion status of the vehicle. For example, in the cases of rapid acceleration, rapid deceleration, sharp turning, and other cases of larger changes in the motion range of the vehicle, the occupant may also be caused to feel carsickness. In this case, the airbags in the pneumatic seat are inflated and deflated, to enable the body of the occupant to be adapted to the change range, thereby helping alleviate the discomfort.

Specifically, in the case of rapid acceleration or rapid deceleration, the control module 2 is further configured to control the inflation and deflation of one or more of the headrest airbag, the shoulder support airbag, the side airbag, the lumbar support airbag, the leg support airbag, and the seat cushion airbag, to push the occupant at a velocity the same as a velocity of the vehicle.

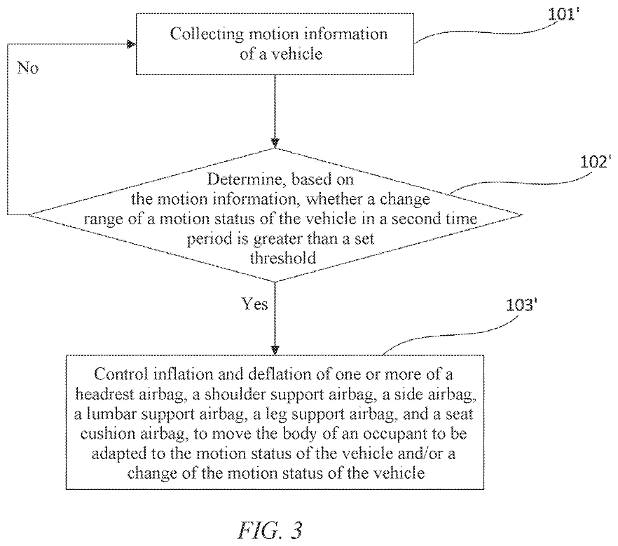

In the embodiment, there is further provided a control method for a pneumatic seat of a vehicle. Referring to FIG. 3, the method includes:
step 101′: collecting motion information of the vehicle;
step 102′: determining, based on the motion information, whether a change range of a motion status of the vehicle in a second time period is greater than a set threshold, and if yes, proceeding to step 103′; or if no, returning to step 101′, where the case of whether the change range reaching a specific level is, for example, rapid acceleration, rapid deceleration, sharp turning, or the like of the vehicle; and
step 103′: controlling inflation and deflation of one or more of the headrest airbag, the shoulder support airbag, the side airbag, the lumbar support airbag, the leg support airbag, and the seat cushion airbag, to move the body of an occupant to be adapted to the motion status of the vehicle and/or a change of the motion status of the vehicle.

In the case of rapid acceleration or rapid deceleration of the vehicle, step 103′ is specifically controlling the inflation and deflation of one or more of the headrest airbag, the shoulder support airbag, the side airbag, the lumbar support airbag, the leg support airbag, and the seat cushion airbag, to push the occupant at a velocity the same as a velocity of the vehicle.

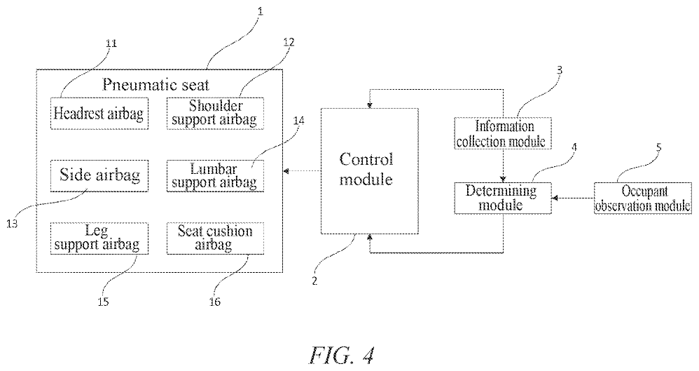

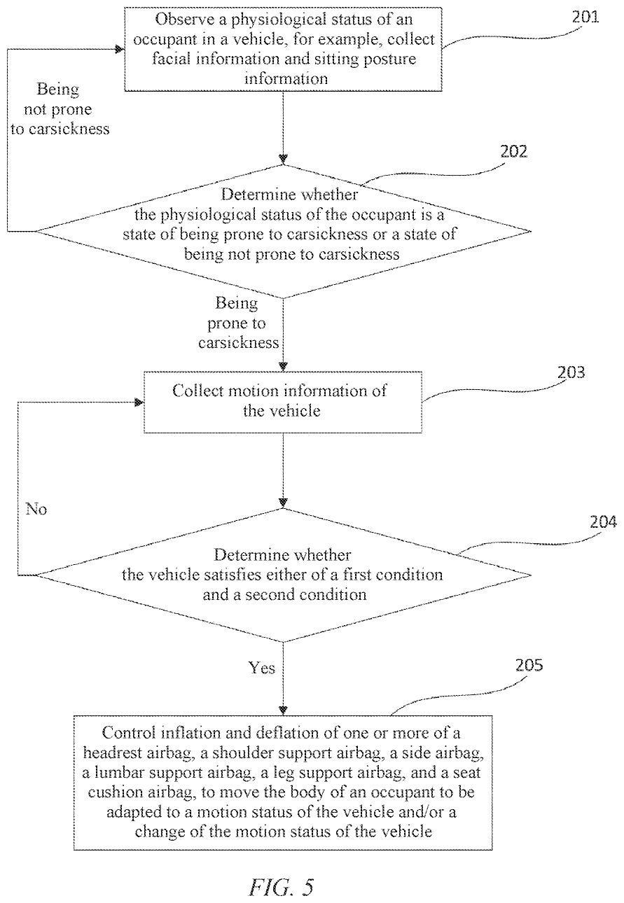

A control system and method for a pneumatic seat of a vehicle according to another embodiment of the invention are described below with reference to FIG. 4 and FIG. 5, respectively.

Referring to FIG. 4 first, the control system for a pneumatic seat of a vehicle in the embodiment is generally the same as the system shown in FIG. 1 (the same reference signs are used for the modules the same as those in FIG. 1), and a difference between the systems lies in that the control system in the embodiment further includes a occupant observation module 5 configured to observe a physiological status of an occupant in the vehicle, where the physiological status includes, for example, a facial expression, the vision, and sitting posture information. Through the observation of the physiological status, whether the occupant has physical discomfort may be determined. The determining module 4 is further configured to determine whether the physiological status of the occupant is a state of being prone to carsickness or a state of being not prone to carsickness, and the determining of a first condition and a second condition is enabled only when the occupant is in the state of being prone to carsickness. The first condition is whether continuous changes have occurred or are about to occur on a motion status of the vehicle in a first time period, and the second condition is whether a change range of the motion status of the vehicle in a second time period is or is about to be greater than a set threshold. The state of being prone to carsickness is, for example, that the occupant is reading, and the state of being not prone to carsickness is, for example, that the occupant is having a rest. These states may be reflected by facial information and sitting posture information of the occupant. In the embodiment, the determining of the motion status of the vehicle is enabled only when the occupant is in the state of being prone to carsickness. In other words, if the occupant is in the state of being not prone to carsickness, even if the vehicle bumps extremely, or there is a large change of a velocity of the vehicle, the occupant is not easy to feel carsickness, and therefore there is no need to adjust and control the airbags of the pneumatic seat.

Correspondingly, the control method for a pneumatic seat of a vehicle in the embodiment also includes a step of observing the physiological status of the occupant, specifically, referring to FIG. 5, including the following steps:
step 201: observing the physiological status of the occupant in the vehicle, for example, collecting facial information and sitting posture information;
step 202: determining whether the physiological status of the occupant is a state of being prone to carsickness (for example, reading or chatting) or a state of being not prone to carsickness (for example, having a rest), and if the occupant is in the state of being prone to carsickness, proceeding to step 203; or if the occupant is in the state of being not prone to carsickness, returning to step 201;
step 203: collecting motion information of the vehicle;
step 204: determining whether the vehicle satisfies either of a first condition and a second condition, where the first condition is whether continuous changes have occurred or are about to occur on a motion status of the vehicle in a first time period, and the second condition is whether a change range of the motion status of the vehicle in a second time period is or is about to be greater than a set threshold; and if yes, proceeding to step 205; or if no, returning to step 203; and
step 205: controlling inflation and deflation of one or more of the headrest airbag, the shoulder support airbag, the side airbag, the lumbar support airbag, the leg support airbag, and the seat cushion airbag, to move the body of the occupant to be adapted to the motion status of the vehicle and/or a change of the motion status of the vehicle.

Specifically, there are two cases in step 204. In one case, whether continuous changes have occurred on the motion status of the vehicle and the change range is greater than the set threshold is determined based on the motion information, that is, the vehicle have entered a state of being likely to cause carsickness, for example, the vehicle may have been changing speeds and turning continuously, or the vehicle may have made a sharp turn with a larger range. In the other case, whether continuous changes are about to occur on the motion status of the vehicle or whether the change range is about to be greater than the set threshold is determined based on the current motion information, that is, the motion status that the vehicle is about to enter may cause the occupant to feel carsickness. In either of the cases, the inflation and deflation of the airbags of the pneumatic seat will be enabled to alleviate the carsickness caused by the motion status.

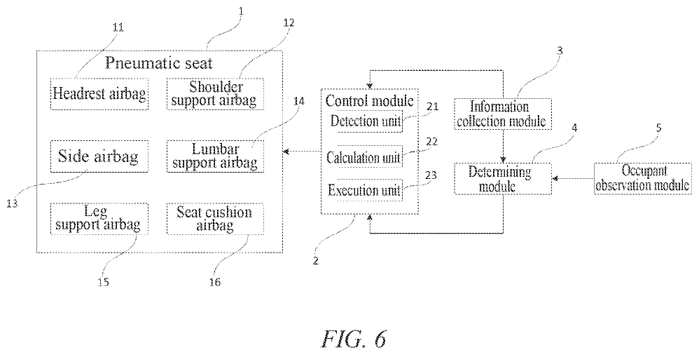

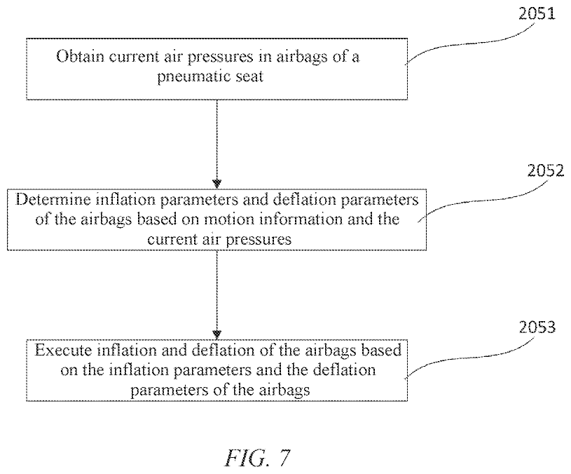

Next, a control system and method for a pneumatic seat of a vehicle according to another preferred embodiment of the invention are described with reference to FIG. 6 and FIG. 7.

Referring to FIG. 6 first, the control system for a pneumatic seat of a vehicle in the embodiment is generally the same as the embodiment illustrated in FIG. 4, and a difference between the systems lies in that: The control module 2 further includes a detection unit 21, a calculation unit 22, and an execution unit 23.

The detection unit 21 is configured to obtain current air pressures in the airbags of the pneumatic seat.

The calculation unit 22 is configured to determine inflation parameters and deflation parameters of the airbags based on the motion information and the current air pressures.

The execution unit 23 is configured to execute inflation and deflation of the airbags based on the inflation parameters and the deflation parameters of the airbags. More specifically, the execution unit 23 is configured to: before, when, or after at least some of the airbags of the pneumatic seat are inflated at a first inflation speed, deflate at least some other airbags of the pneumatic seat at a second deflation speed. The first inflation speed may be the same as or different from the second deflation speed. Alternatively, the execution unit 23 is configured to: after at least one airbag of the pneumatic seat is inflated at a third inflation speed to a first pressure, inflate the airbag at a fourth inflation speed to a second pressure. For example, the third inflation speed is greater than the fourth inflation speed, that is, quick inflation is performed first and then slow inflation is performed.

Referring to FIG. 7 below, the control method for a pneumatic seat of a vehicle in the embodiment is described. The method is generally the same as the method illustrated in FIG. 5, and a difference between the methods lies in that the control over the airbags (step 205) specifically includes the following steps:
step 2051: obtaining current air pressures in the airbags of the pneumatic seat;
step 2052: determining inflation parameters and deflation parameters of the airbags based on the motion information and the current air pressures; and
step 2053: executing the inflation and deflation of the airbags based on the inflation parameters and the deflation parameters of the airbags. In step 2053, before, when, or after at least some of the airbags of the pneumatic seat are inflated at the first inflation speed, at least some other airbags of the pneumatic seat are deflated at the second deflation speed. The first inflation speed may be the same as or different from the second deflation speed. Alternatively, after at least one airbag of the pneumatic seat is inflated at the third inflation speed to the first pressure, the airbag is inflated at the fourth inflation speed to the second pressure. For example, the third inflation speed is greater than the fourth inflation speed, that is, quick inflation is performed first and then slow inflation is performed.

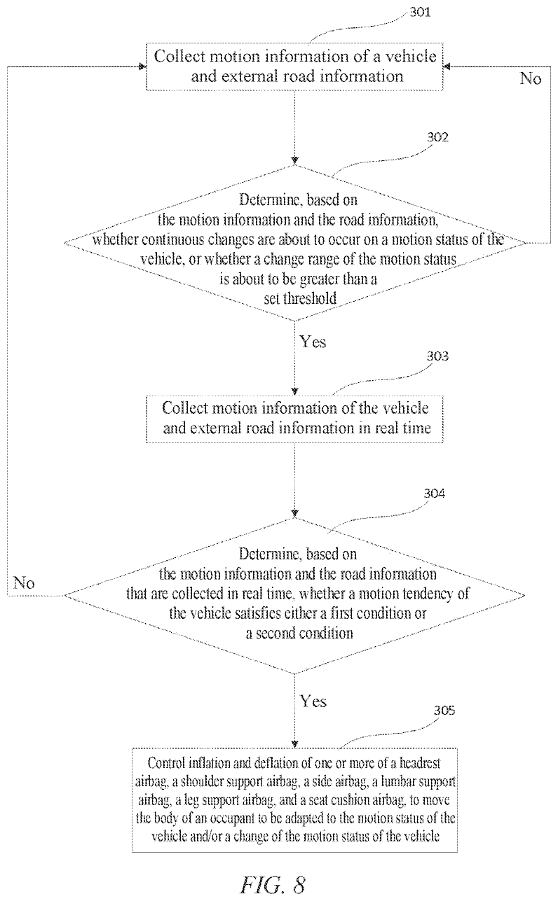

A control system and method for a pneumatic seat of a vehicle according to still another preferred embodiment of the invention are described below with reference to FIG. 1 and FIG. 8.

Referring to FIG. 1, the control system for a pneumatic seat of a vehicle in the embodiment also includes the modules shown in FIG. 1, the modules also have the functions of those of the embodiment illustrated in FIG. 1, and a difference between them lies in that: The information collection module is configured to collect motion information of the vehicle and external road information.

In addition, the determining module is configured to determine, based on the motion information and the road information, whether the vehicle satisfies either of a first condition and a second condition, where the first condition is whether continuous changes have occurred or are about to occur on a motion status of the vehicle in a first time period, and the second condition is whether a change range of the motion status of the vehicle in a second time period is or is about to be greater than a set threshold.

Further, when the determining module determines that continuous changes are about to occur on the motion status of the vehicle in the first time period, and/or determines that the change range of the motion status of the vehicle in the second time period is about to be greater than the set threshold, the determining module is further configured to determine a motion tendency of the vehicle based on the motion information of the vehicle and the external road information that are collected in real time by the information collection module; and the control module is configured to: when the motion tendency satisfies either of the first condition and the second condition, control inflation and deflation of one or more of the headrest airbag, the shoulder support airbag, the side airbag, the lumbar support airbag, the leg support airbag, and the seat cushion airbag, to move the body of an occupant to be adapted to the motion status of the vehicle and/or a change of the motion status of the vehicle. In other words, in the embodiment, the determining module is configured to determine the motion tendency of the vehicle based on the motion information and the road information, for example, the road information indicates that a winding mountain highway is about to appear in a traveling direction of the vehicle. If the motion tendency of the vehicle is that continuous steering is about to occur, whether the motion tendency of continuous steering has occurred or is about to occur is verified based on the motion information and the road information that are collected in real time by the information collection module, so as to control inflation and deflation of corresponding airbags.

Alternatively, when the determining module determines that a change is about to occur in a velocity in the traveling direction of the vehicle, and it is found, based on the motion information collected in real time, that continuous changes have occurred in the velocity and acceleration in the traveling direction of the vehicle, the control module is configured to control the inflation of the seat cushion airbag and the leg support airbag, to prevent a displacement of the occupant in the traveling direction of the vehicle, and the control module is further configured to control the inflation and deflation of the seat cushion airbag to generate vibration to prompt the occupant.

Accordingly, referring to FIG. 8, the control method for a pneumatic seat of a vehicle in the embodiment includes the following steps:
step 301: collecting motion information of the vehicle and external road information;
step 302: determining, based on the motion information and the road information, whether continuous changes are about to occur on the motion status of the vehicle, or whether a change range of the motion status is about to be greater than a set threshold, and if yes, proceeding to step 303; or if no, returning to step 301;
step 303: collecting motion information of the vehicle and external road information in real time;
step 304: determining, based on the motion information and the road information that are collected in real time, whether the motion tendency of the vehicle satisfies either the first condition or the second condition, and if yes, proceeding to step 305; or if no, returning to step 301; and
step 305: controlling inflation and deflation of one or more of the headrest airbag, the shoulder support airbag, the side airbag, the lumbar support airbag, the leg support airbag, and the seat cushion airbag, to move the body of an occupant to be adapted to the motion status of the vehicle and/or a change of the motion status of the vehicle.

In the control method, the motion information and the road information are collected simultaneously, the motion tendency of the vehicle is determined first based on the collected information in step 302, and when it is estimated that the vehicle may satisfy either the first condition or the second condition, for example, a winding mountain highway may appear in the front or the road in the front to be passed through is bumpy, the determining is verified based on the motion information and the road information that are collected in real time, for example, when it is found, based on the collected motion information, that a change occurs in a force received by the vehicle in a direction perpendicular to the ground, it is considered that the determining in step 302 is verified, and then the corresponding airbags are controlled to be inflated and deflated to implement the support for the occupant, to alleviate the discomfort caused by carsickness. Alternatively, when it is determined, based on the road information, that congestion may occur in the traveling direction of the vehicle, that is, continuous changes may occur in the velocity, the motion tendency of the vehicle is determined based on the motion information of the vehicle and the external road information that are collected in real time, and if it is determined that there are continuous changes in the velocity and acceleration in the traveling direction of the vehicle, the seat cushion airbag and the leg support airbag are controlled to be inflated to prevent a displacement of the occupant in the traveling direction of the vehicle, and the inflation and deflation of the seat cushion airbag are controlled to generate vibration to prompt the occupant.

The invention further provides a computer-readable medium, where the computer-readable medium stores computer instructions that, when executed by a processor, implement the steps of the control method for a pneumatic seat of any one of the above.

According to the invention, the airbags disposed at positions, corresponding to the body parts of the occupant, in the pneumatic seat are utilized in combination with the motion information of the vehicle, the external road information, and the physiological status of the occupant in the vehicle, so that different inflation and deflation operations are performed on the airbags in a driving process of being likely to cause the occupant to feel carsickness or when it is predicted that carsickness may occur, so as to protect the occupant from carsickness, and improve the ride comfort of the occupant.

Although the specific embodiments of the present invention are described above, it should be appreciated by those skilled in the art that these are merely illustrative and that the scope of protection of the present invention is defined by the appended claims. Various changes or modifications to these embodiments may be made by those skilled in the art without departing from the principle and spirit of the present invention, and these changes or modifications fall within the scope of the present invention.

1. A control system for a pneumatic seat of a vehicle, the pneumatic seat comprising at least one headrest airbag, a shoulder support airbag, at least one side airbag, at least one lumbar support airbag, at least one leg support airbag, and at least one seat cushion airbag, wherein the control system for a pneumatic seat further comprises an information collection module, a determining module, and a control module, wherein
the information collection module is configured to collect motion information of the vehicle and/or external road information;
the determining module is configured to determine, based on the motion information and/or the road information, whether the vehicle satisfies either of a first condition and a second condition, wherein the first condition is whether continuous changes have occurred or are about to occur on a motion status of the vehicle in a first time period, and the second condition is whether a change range of the motion status of the vehicle in a second time period is or is about to be greater than a set threshold; and
the control module is configured to: when either of the first condition and the second condition is satisfied, control inflation and deflation of one or more of the headrest airbag, the shoulder support airbag, the side airbag, the lumbar support airbag, the leg support airbag, and the seat cushion airbag, to move the body of an occupant to be adapted to the motion status of the vehicle and/or a change of the motion status of the vehicle.

2. The control system for a pneumatic seat of claim 1, wherein the control system for a pneumatic seat further comprises an occupant observation module configured to observe a physiological status of the occupant in the vehicle; and
the determining module is further configured to: determine whether the physiological status of the occupant is a state of being prone to carsickness or a state of being not prone to carsickness, and enable the determining of the first condition and the second condition only when the occupant is in the state of being prone to carsickness.

3. The control system for a pneumatic seat of claim 1, wherein the physiological status comprises facial information and sitting posture information.

4. The control system for a pneumatic seat of claim 1, wherein the motion information comprises: a velocity, an acceleration, an acceleration change amount, an angular velocity, and an angular acceleration change amount that are in a traveling direction of the vehicle; and a velocity in a direction perpendicular to the ground, and a force and a force change received in the direction perpendicular to the ground; and/or
the road information comprises a length, a width, a direction that are of a road, and an included angle between the road and the ground.

5. The control system for a pneumatic seat of claim 1, wherein the control module is further configured to control the inflation and deflation of one or more of the headrest airbag, the shoulder support airbag, the side airbag, the lumbar support airbag, the leg support airbag, and the seat cushion airbag, to push the occupant in a direction the same as a motion direction of the vehicle.

6. The control system for a pneumatic seat of claim 1, wherein the control module is further configured to control the inflation and deflation of one or more of the headrest airbag, the shoulder support airbag, the side airbag, the lumbar support airbag, the leg support airbag, and the seat cushion airbag, to push the occupant at a velocity the same as a velocity of the vehicle.

7. The control system for a pneumatic seat of claim 1, wherein when the determining module determines that continuous changes occur in the velocity and/or the acceleration in the traveling direction of the vehicle, the control module is configured to control inflation of the seat cushion airbag and/or the leg support airbag, to prevent a displacement of the occupant in the traveling direction of the vehicle, and/or the control module is configured to control inflation and deflation of the seat cushion airbag to generate vibration.

8. The control system for a pneumatic seat of claim 1, wherein when the determining module determines that continuous changes occur in the angular velocity and/or the angular acceleration of the vehicle, the control module is configured to control inflation of the side airbag.

9. The control system for a pneumatic seat of claim 1, wherein when the determining module determines that a change occurs or continuous changes occur in the velocity of the vehicle in the direction perpendicular to the ground and/or a change occurs or continuous changes occur in the force received by the vehicle in the direction perpendicular to the ground, the control module is configured to control the inflation and deflation of one or more of the headrest airbag, the shoulder support airbag, the side airbag, the lumbar support airbag, the leg support airbag, and the seat cushion airbag, to reduce a displacement of the occupant in the direction perpendicular to the ground.

10. The control system for a pneumatic seat of claim 1, wherein when the determining module determines that continuous changes are about to occur on the motion status of the vehicle in the first time period, and/or determines that the change range of the motion status of the vehicle in the second time period is about to be greater than the set threshold, the determining module is further configured to determine a motion tendency of the vehicle based on the motion information of the vehicle and/or the external road information that are collected in real time by the information collection module; and
the control module is configured to: when the motion tendency satisfies either of the first condition and the second condition, control the inflation and deflation of one or more of the headrest airbag, the shoulder support airbag, the side airbag, the lumbar support airbag, the leg support airbag, and the seat cushion airbag, to move the body of the occupant to be adapted to the motion status of the vehicle and/or a change of the motion status of the vehicle.

11. The control system for a pneumatic seat of claim 1, wherein the control module comprises a detection unit, a calculation unit, and an execution unit, wherein
the detection unit is configured to obtain current air pressures in the airbags of the pneumatic seat;
the calculation unit is configured to determine inflation parameters and deflation parameters of the airbags based on the motion information and the current air pressures; and
the execution unit is configured to execute the inflation and deflation of the airbags based on the inflation parameters and the deflation parameters of the airbags.

12. The control system for a pneumatic seat of claim 11, wherein the execution unit is configured to: before, when, or after at least some of the airbags of the pneumatic seat are inflated at a first inflation speed, deflate at least some other airbags of the pneumatic seat at a second deflation speed.

13. The control system for a pneumatic seat of claim 11, wherein the execution unit is configured to: after at least one airbag of the pneumatic seat is inflated at a third inflation speed to a first pressure, inflate the airbag at a fourth inflation speed to a second pressure.

14. A control method for a pneumatic seat of a vehicle, the pneumatic seat comprising at least one headrest airbag, a shoulder support airbag, at least one side airbag, at least one lumbar support airbag, at least one leg support airbag, and at least one seat cushion airbag, wherein the control method for the pneumatic seat comprises:
S1: collecting motion information of the vehicle and/or external road information;
S2: determining, based on the motion information and/or the road information, whether the vehicle satisfies either of a first condition and a second condition, and if either of the first condition and the second condition is satisfied, proceeding to step S3; or if neither the first condition nor the second condition is satisfied, returning to step S1, wherein the first condition is whether continuous changes have occurred or are about to occur on a motion status of the vehicle in a first time period, and the second condition is whether a change range of the motion status of the vehicle in a second time period is or is about to be greater than a set threshold; and
S3: controlling inflation and deflation of one or more of the headrest airbag, the shoulder support airbag, the side airbag, the lumbar support airbag, the leg support airbag, and the seat cushion airbag, to move the body of an occupant to be adapted to the motion status of the vehicle and/or a change of the motion status of the vehicle.

15. The control method for the pneumatic seat of claim 14, wherein before step S2, the method further comprises:
ST1: observing a physiological status of the occupant in the vehicle; and
ST2: determining whether the physiological status of the occupant is a state of being prone to carsickness or a state of being not prone to carsickness, and if the occupant is in the state of being prone to carsickness, proceeding to step S2; or if the occupant is in the state of being not prone to carsickness, returning to step ST1.

16. The control method for the pneumatic seat of claim 15, wherein the physiological status comprises facial information and sitting posture information; and/or
steps ST1 and ST2 are performed before step S1 or performed simultaneously with step S1.

17. The control method for the pneumatic seat of claim 14, wherein the motion information comprises: a velocity, an acceleration, an acceleration change amount, an angular velocity, and an angular acceleration change amount that are in a traveling direction of the vehicle; and a velocity in a direction perpendicular to the ground, and a force and a force change received in the direction perpendicular to the ground; and/or
the road information comprises a length, a width, a direction that are of a road, and an included angle between the road and the ground.

18. The control method for the pneumatic seat of claim 14, wherein the inflation and deflation of one or more of the headrest airbag, the shoulder support airbag, the side airbag, the lumbar support airbag, the leg support airbag, and the seat cushion airbag are controlled in step S3, to push the occupant in a direction the same as a motion direction of the vehicle.

19. The control method for the pneumatic seat of claim 14, wherein the inflation and deflation of one or more of the headrest airbag, the shoulder support airbag, the side airbag, the lumbar support airbag, the leg support airbag, and the seat cushion airbag are controlled in step S3, to push the occupant at a velocity the same as a velocity of the vehicle.

20. The control method for the pneumatic seat of claim 14, wherein when it is determined, in step S2, that continuous changes occur in the velocity and/or the acceleration in the traveling direction of the vehicle,
step S3 comprises: controlling inflation of the seat cushion airbag and/or the leg support airbag, to prevent a displacement of the occupant in the traveling direction of the vehicle, and/or controlling inflation and deflation of the seat cushion airbag to generate vibration.

21. The control method for the pneumatic seat of claim 14, wherein when it is determined, in step S2, that continuous changes occur in the angular velocity and/or the angular acceleration of the vehicle,
step S3 comprises: controlling inflation of the side airbag.

22. The control method for the pneumatic seat of claim 14, wherein when it is determined, in step S2, that a change occurs in the velocity of the vehicle in the direction perpendicular to the ground and/or a change occurs in the force received by the vehicle in the direction perpendicular to the ground,
step S3 comprises: controlling the inflation and deflation of one or more of the headrest airbag, the shoulder support airbag, the side airbag, the lumbar support airbag, the leg support airbag, and the seat cushion airbag, to reduce a displacement of the occupant in the direction perpendicular to the ground.

23. The control method for the pneumatic seat of claim 14, wherein step S2 comprises:
S21: determining whether continuous changes are about to occur on the motion status of the vehicle in the first time period, or whether the change range of the motion status of the vehicle in the second time period is about to be greater than the set threshold, and if either the first condition or the second condition is satisfied, proceeding to step S22; or if neither the first condition nor the second condition is satisfied, returning to step S1; and
S22: determining a motion tendency of the vehicle based on the motion information of the vehicle and/or the external road information that are collected in real time, and if the motion tendency satisfies either of the first condition and the second condition, proceeding to step S3; or if neither the first condition nor the second condition is satisfied, returning to step S1.

24. The control method for the pneumatic seat of claim 14, wherein step S3 comprises:
S31: obtaining current air pressures in the airbags of the pneumatic seat;
S32: determining inflation parameters and deflation parameters of the airbags based on the motion information and the current air pressures; and
S33: executing the inflation and deflation of the airbags based on the inflation parameters and the deflation parameters of the airbags.

25. The control method for the pneumatic seat of claim 24, wherein step S33 comprises: before, when, or after at least some of the airbags of the pneumatic seat are inflated at a first inflation speed, deflating at least some other airbags of the pneumatic seat at a second deflation speed.

26. The control method for the pneumatic seat of claim 24, wherein step S33 comprises: after at least one airbag of the pneumatic seat is inflated at a third inflation speed to a first pressure, inflating the airbag at a fourth inflation speed to a second pressure.

27. A computer-readable medium, wherein the computer-readable medium stores computer instructions that, when executed by a processor, implement steps of the control method for the pneumatic seat of claim 14.
